(19) United States
(12) Patent Application Publication
(10) Pub. No.: US 2026/0360381 A1
(43) Pub. Date: Nov. 12, 2026

(54) WEARABLE DEVICE SPEECH ENHANCEMENT

(71) Applicant: GOOGLE LLC, Mountain View, CA (US)

(72) Inventors: Joseph Caroselli, JR., Palo Alto, CA (US); Jens Heitkaemper, Mountain View, CA (US); Arun Narayanan, Milpitas, CA (US); Nathan David Howard, Mountain View, CA (US); Maxwell McKinnon, San Mateo, CA (US)

(21) Appl. No.: 19/229,876

(22) Filed: Jun. 5, 2025

Related U.S. Application Data
(60) Provisional application No. 63/800,889, filed on May 6, 2025.

(51) Int. Cl. G10L 21/0216; H04R 1/10; H04R 5/027

(52) U.S. Cl. CPC G10L 21/0216; H04R 1/1091; H04R 5/027; G10L 2021/02165

(57) ABSTRACT

Implementations described herein are directed to processing audio data from multiple microphones of a wearable device to enhance the audio data prior to processing by additional system(s). In some implementations, processor(s) of a system can receive first audio data capturing a spoken utterance, and can receive second audio data capturing the same spoken utterance. The first audio data can be generated by a first microphone of the wearable device and the second audio data can be generated by a second microphone of the wearable device. Further, the processor(s) can process, using a speech enhancement machine learning model, the first audio data and the second audio data to generate an auditory mask. Further, the processor(s) can apply the auditory mask to the first audio data to generate masked audio data, which can then be provided for processing by the additional system(s).

### BACKGROUND

The use of voice commands to control devices and access information has become increasingly prevalent. This is driven by the increasing sophistication of automated assistants and the proliferation of wearable devices equipped with microphones. One challenge in this field is ensuring accurate speech recognition and/or processing, particularly in noisy environments.

Many existing speech recognition and/or processing systems rely on audio data generated by a single microphone. These systems often struggle in environments with high levels of background noise, such as crowded public spaces or windy outdoor settings. The noise degrades the quality of the captured speech, leading to errors in speech recognition and/or processing. To mitigate the effects of noise, some of these systems employ noise reduction algorithms. These algorithms attempt to filter out unwanted sounds from the audio data. However, these techniques often rely on statistical assumptions about the nature of the noise, and can be ineffective when the noise is non-stationary or spectrally similar to speech. Furthermore, aggressive noise reduction can distort the voice commands captured in the audio data, further hindering accurate recognition and/or processing.

More advanced systems utilize multiple microphones to improve speech recognition and/or processing in noisy environments. These systems often employ techniques such as beamforming, which spatially filters the audio data to focus on the desired speaker while suppressing noise sources from other directions. While beamforming can improve the signal-to-noise ratio (SNR), it typically requires a relatively large microphone array and precise knowledge of the speaker's location. These requirements can be difficult to meet in practice, particularly for compact wearable devices like earbuds.

Therefore, there remains a need for improved speech enhancement techniques that can effectively address the challenges of noisy environments, and particularly for compact wearable devices.

### SUMMARY

Implementations described herein are directed to processing audio data from multiple microphones of a wearable device to enhance the audio data prior to processing by additional system(s). In some implementations, processor(s) of a system can receive first audio data capturing a spoken utterance, and can receive second audio data capturing the same spoken utterance. The first audio data can be generated by a first microphone of the wearable device and the second audio data can be generated by a second microphone of the wearable device. Further, the processor(s) can process, using a speech enhancement machine learning model, the first audio data and the second audio data to generate an auditory mask. Further, the processor(s) can apply the auditory mask to the first audio data to generate masked audio data, which can then be provided for processing by the additional system(s). In additional or alternative implementations, accelerometer data generated by accelerometer(s) of the wearable device can be utilized, in addition to or in lieu of, the second audio data in generating the auditory mask.

Implementations disclosed herein can mitigate (e.g., eliminate) various drawbacks with current techniques. For example, the need for large microphone arrays and precise knowledge of the speaker's location, required by traditional beamforming techniques, can be reduced or eliminated through the use of machine learning models that are trained to operate effectively with the audio data captured by closely spaced microphones on wearable devices. As another example, the distortion of voice commands caused by aggressive noise reduction techniques can be avoided by using machine learning models to generate auditory masks that selectively filter noise while preserving speech characteristics. As another example, the techniques disclosed herein are applicable to compact wearable devices like earbuds, where microphone array size is constrained.

As a non-limiting example of some implementations disclosed herein, assume that a user is wearing a pair of wireless earbuds in a crowded coffee shop. The earbuds may be equipped with at least two microphones - one facing outwards to capture ambient sound and the user's voice, and another facing inwards towards the ear canal to capture the user's voice with less background noise. Further assume that the user initiates a voice command, such as "Call Mom." In this example, the outward-facing microphone can capture the user's speech along with other sounds in the coffee shop, such as the whirring of the espresso machine and snippets of conversations from nearby tables. Further, the inward-facing microphone can capture a cleaner version of the user's speech, albeit potentially muffled and with different frequency characteristics.

The captured audio data from both microphones can be processed using a speech enhancement machine learning model executing on the user's smartphone, which can be wirelessly connected to the earbuds, or executing at a remote system, which can be wirelessly connected to the user's smartphone. The speech enhancement machine learning model can process the two streams of audio data and generate an auditory mask that selectively attenuates the noise components in the audio data from the outward-facing microphone while preserving the user's speech. This auditory mask can then be applied to the audio stream from the outward-facing microphone, resulting in a noise-reduced, enhanced audio data. This enhanced audio data is then passed on to an automatic speech recognition (ASR) system, a generative model (GM) system, and/or other systems for further processing.

In some implementations, and as described in the above example, the wearable device can be an earbud that includes multiple microphones. For instance, one microphone could be positioned to face outwards, capturing both the user's speech and environmental noise. Another microphone could face inwards, directed towards the user's ear, capturing a more direct and less noisy version of their speech. In such scenarios, the auditory mask can then filter out much of the environmental noise captured by the outward-facing microphone. However, it should be understood that techniques described herein can be implemented with other wearable devices, such as wearable computerized glasses that include multiple microphones, wearable smart watches that include microphones, etc. While some of these other devices may not include a microphone that is facing inwards, directed towards the user's ear, these multiple microphones may still face in different directions and enhancing audio data generated by these microphones can still have the same or similar benefits in terms of, for example, noise reduction.

In some implementations, and prior to processing the first audio data and the second audio data to generate the auditory mask and using the speech enhancement machine learning model, the processor(s) can determine whether to use the speech enhancement machine learning model based on a mode of operation of the wearable device. The mode of operation of the wearable device can be one of a plurality of different modes of operation. For example, assuming the wearable device is an earbud, the plurality of different modes of operation can include, for instance, a transparency mode, a noise cancellation mode, an adaptive listening mode, an off mode, or other modes. In these implementations, the processor(s) may only use the speech enhancement machine learning model when the earbud is in a non-transparency mode (e.g., when the earbud is in a noise cancellation mode, an adaptive listening mode, or an off mode). This is due to transparency mode allowing noise to flow inwards which can be captured in the second audio data.

In some implementations, the speech enhancement machine learning model can be a conformer-based machine learning model that is trained to generate the auditory mask. A conformer-based model uses a combination of convolution and self-attention mechanisms to effectively model both local and global dependencies in the audio data, leading to more accurate auditory masks and improved speech enhancement.

In some implementations, and prior to receiving the first audio data and the second audio data, the processor(s) can train the speech enhancement machine learning model based on a plurality of training instances. For example, the speech enhancement machine learning model can be trained using a large dataset of synthesized audio data. This dataset includes synthesized spoken utterances combined with various types of synthesized noise and/or varied gain levels or noise types. For example, a given training instance can include, as training instance input, first training audio data that captures a synthesized spoken utterance and synthesized noise and second training audio data that captures the synthesized spoken utterance with a varied gain level and/or varied synthesized noise. Further, the given training instance can include, as training instance output, ground truth audio data that captures the synthesized spoken utterance without any of the synthesized noise and/or without any of the varied gain level.

In training the speech enhancement machine learning model based on the given training instance, the processor(s) can process, using the speech enhancement machine learning model, the first training audio data and the second training audio data to generate a predicted auditory mask. Further, the processor(s) can apply the predicted auditory mask to the first training audio data to generate predicted masked audio data. Moreover, the processor(s) can generate, based on comparing the predicted masked audio data to the ground truth audio data, loss(es) and can cause the speech enhancement machine learning model to be updated based on the loss(es). Comparing the predicted masked audio data to the ground truth audio data can include, for example, comparing acoustic features of the predicted masked audio data to acoustic features of the ground truth audio data, comparing a waveform corresponding to the predicted masked audio data to a waveform corresponding to the ground truth audio data, and/or other making other comparisons based on which the loss(es) can be generated. Additional, or alternative, losses can be utilized in updating the speech enhancement machine learning model as described herein (e.g., ASR loss(es)). In these and other manners described herein, the processor(s) effectively train the speech enhancement machine learning model to generate auditory masks that can effectively remove noise and recover original, clean speech.

In some versions of those implementations, and subsequent to training the speech enhancement machine learning model, the processor(s) can fine-tune the speech enhancement machine learning model based on a plurality of fine-tuning instances. For example, the speech enhancement machine learning model can be fine-tuned using a small dataset of real audio data. This dataset includes real spoken utterances combined with various types of real noise. For example, a given fine-tuning instance can include, as training instance input, first fine-tuning audio data that captures a real spoken utterance and real noise and second training audio data that captures the real spoken utterance. Further, the given fine-tuning instance can include, as training instance output, ground truth audio data that captures the real spoken utterance without any of the noise.

In fine-tuning the speech enhancement machine learning model based on the given fine-tuning instance, the processor(s) can perform the same or similar operations described above with respect to training the speech enhancement machine learning model, but using the given fine-tuning instance instead of the given training instance. By fine-tuning the speech enhancement machine learning model on real audio data, it becomes more adept at handling the complexities and variations of real-world noise conditions. Although the speech enhancement machine learning is described with respect to being trained using synthesized data and fine-tuned using real data, it should be understood that is for the sake of example and is not meant to be limiting. Rather, it should be understood that the speech enhancement machine learning model can be trained and fine-tuned using synthesized data, trained using real data and fine-tuned using synthesized data, or trained and fine-tuned using real data. However, availability of data for utilization in training and/or fine-tuning instances may impact what type of data is used to train and/or fine-tune the speech enhancement machine learning model.

In some implementations, the audio enhancement process can utilize accelerometer data generated by accelerometer(s) of the wearable device. In some implementations, the processor(s) can convert the accelerometer data to narrowband audio data, and the speech enhancement machine learning model then processes this narrowband audio data, along with the first audio data and the second audio data, or the narrowband audio data along with the first audio data and in lieu of the second audio data (e.g., when the wearable device is an earbud in transparency mode), to generate the auditory mask. In these implementations, the processor(s) can convert the accelerometer data to the narrowband audio data by sampling the accelerometer data with a predetermined sampling frequency.

In some implementations, the processor(s) can be executed locally at a client device of a user, like at a smartphone, which is in wireless communication with the wearable device. In these implementations, the masked audio data can then be processed by an on-device automatic speech recognition (ASR) model to generate text that can then be further processed, or the masked audio data can then be processed by an on-device generative model (GM) to create responsive content.

In additional or alternative implementations, the processor(s) can be executed remotely from a client device of a user, like at high-performance server(s), which is in wireless communication with the client device of the user. In these implementations, the masked audio data can then be processed by a remote automatic speech recognition (ASR) model to generate text that can then be further processed, or the masked audio data can then be processed by a remote generative model (GM) to create responsive content.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart illustrating an example method of training a speech enhancement machine learning model, in accordance with various implementations.

FIG. 3 depicts a flowchart illustrating an example method of using a speech enhancement machine learning model to enhance speech, in accordance with various implementations.

FIG. 4 depicts a flowchart illustrating another example method of using a speech enhancement machine learning model to enhance speech, in accordance with various implementations.

FIG. 5 depicts an example architecture of a computing device, in accordance with various implementations.

### DETAILED DESCRIPTION

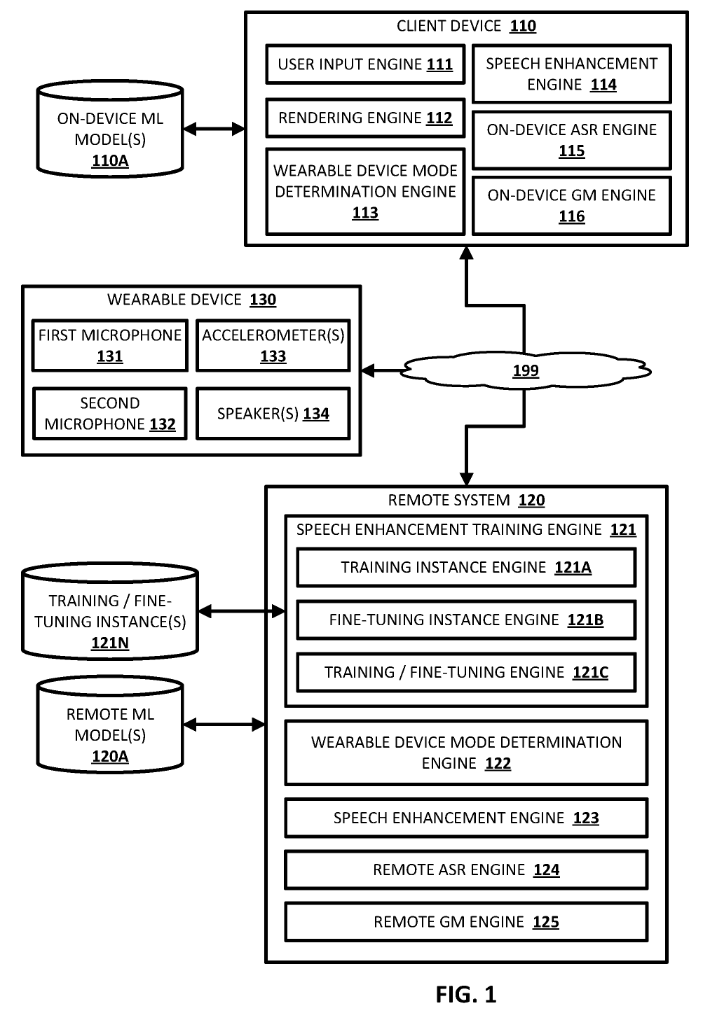

Turning now to FIG. 1, a block diagram of an example environment that demonstrates various aspects of the present disclosure, and in which implementations disclosed herein can be implemented is depicted. The example environment includes a client device 110, a remote system 120, and a wearable device 130. The client device 110, the remote system 120, and/or the wearable device 130 can be communicatively coupled via one or more networks 199, such as one or more wired or wireless local area networks (“LANs,” including Wi-Fi®, mesh networks, Bluetooth®, near-field communication, etc.) or wide area networks (“WANs”, including the Internet). For example, the client device 110 can be communicatively coupled to both the remote system 120 and the wearable device 130. In some implementations, the wearable device 130 may only be communicatively coupled to the client device 110, but can transmit data to the remote system 120 via the client device 110. In additional or alternative implementations, the wearable device 130 may be communicatively to the remote system 120 and transmit data directly to the remote system 120.

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), and/or a smart appliance such as a smart television. Additional and/or alternative client devices may be provided. Further, the client device 110 is depicted as including a user input engine 111, a rendering engine 112, a wearable device mode determination engine 113, a speech enhancement engine 114, an on-device automatic speech recognition (ASR) engine 115, and an on-device generative model (GM) engine 116. Some of these engines can be combined and/or omitted in various implementations. Moreover, the client device 110 is depicted as having access to on-device machine learning (ML) model(s) database 110A.

The remote system 120 can be, for example, a high-performance server or cluster of high performance servers. Additional and/or alternative remote systems may be provided. Further, the remote system 120 is depicted as including speech enhancement training engine 121, wearable device mode determination engine 122, speech enhancement engine 123, remote ASR engine 124, and remote GM engine 125. The speech enhancement training engine 121 is further depicted as including training instance engine 121A, fine-tuning instance engine 121B, and training / fine-tuning engine 121C. Some of these engines and/or sub-engines can be combined and/or omitted in various implementations. Moreover, the remote system 120 is depicted as having access to remote ML model(s) database 120A and training / fine-tuning instance(s) database 121N.

The wearable device 130 can be, for example, a smartwatch of the user having a computing device, glasses of the user having a computing device, a virtual or augmented reality computing device, and/or an earbud having a computing device. Additional and/or wearable devices may be provided. The wearable device is depicted as including a first microphone 131, a second microphone 132, one or more accelerometers 133, and one or more speakers 134. Some of these components can be combined and/or omitted in various implementations.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 110. Additionally, or alternatively, the client device 110 can be equipped with one or more interfaces that are configured to receive content (e.g., document(s), image(s), video(s), audio, etc.) provided by the user of the client device 110.

In some versions of those implementations, the client device 110 can utilize one or more ML model(s) stored in the on-device ML model(s) database 110A and/or the remote ML model(s) database 120A to process the user input. For example, the user input received at the client device 110 or the wearable device 130 may be a spoken utterance. In some of these examples, the on-device ASR engine 115 and/or the remote ASR engine 124 can process, using automatic speech recognition (ASR) model(s) (e.g., a recurrent neural network (RNN) model, a transformer-based ML model, and/or any other type of ML model capable of performing ASR), audio data that captures the spoken utterance and that is generated by microphone(s) of the client device 110 to generate ASR output, generated by microphone(s) of the wearable device 130 to generate ASR output, or masked audio data generated using the speech enhancement engine 114 of the client device 110 and/or the speech enhancement engine 123 of the remote system 120 to generate ASR output. The ASR output can include, for example, speech hypotheses (e.g., term hypotheses and/or transcription hypotheses) that are predicted to correspond to the spoken utterance captured in the audio data, one or more corresponding predicted values (e.g., probabilities, log likelihoods, and/or other values) for each of the speech hypotheses, a plurality of phonemes that are predicted to correspond to the spoken utterance captured in the audio data, one or more corresponding predicted values (e.g., probabilities, log likelihoods, and/or other values) for each of the plurality of phonemes, and/or other ASR output. In these implementations, the on-device ASR engine 115 and/or the remote ASR engine 124 can select one or more of the speech hypotheses as recognized text that corresponds to the spoken utterance (e.g., based on the corresponding predicted values for each of the speech hypotheses), such as when the on-device ASR engine 115 and/or the remote ASR engine 124 utilizes an end-to-end ASR model. In other implementations, the on-device ASR engine 115 and/or the remote ASR engine 124 can select one or more of the predicted phonemes (e.g., based on the corresponding predicted values for each of the predicted phonemes), and determine recognized text that corresponds to the spoken utterance based on the one or more predicted phonemes that are selected, such as when the on-device ASR engine 115 and/or the remote ASR engine 124 utilizes an ASR model that is not end-to-end. In these implementations, the on-device ASR engine 115 and/or the remote ASR engine 124 can optionally employ additional mechanisms (e.g., a directed acyclic graph) to determine the recognized text that corresponds to the spoken utterance based on the one or more predicted phonemes that are selected.

In other of these examples, the on-device GM engine 116 and/or the remote GM engine 125 can process, using GM(s), the ASR output and/or audio data that captures the spoken utterance and that is generated by microphone(s) of the client device 110 to generate responsive content, generated by microphone(s) of the wearable device 130 to generate responsive content, or masked audio data generated using the speech enhancement engine 114 of the client device 110 and/or the speech enhancement engine 123 of the remote system 120 to generate responsive content. As described herein, a GM can be any machine learning model capable of generating generative vision data, generative audio data, generative textual data, and/or other forms of generative data. Some non-limiting examples of machine learning models that are capable of generating one or more forms of the generative data noted above include transformer-based machine learning models (e.g., encoder-decoder transformer models, encoder-only transformer models, decoder-only transformer models, etc. that employ an attention mechanism), diffusion-based machine learning models, recurrent neural network-based machine learning models, generative adversarial network-based machine learning models, sequence-to-sequence machine learning models, etc. Various machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.).

In various implementations, the client device 110 can include a rendering engine 112 that is configured to render content for audible and/or visual presentation to a user of the client device 110 using one or more user interface output devices. For example, the client device 110 can be equipped with speaker(s) that enable the content to be rendered as audible content via the client device 110. Additionally, or alternatively, the client device 110 can be equipped with a display or projector that enables the content to be rendered as textual content, and optionally along with other visual content (e.g., image(s), video(s), etc.), via the client device 110.

In some versions of those implementations, the client device 110 can utilize one or more of the ML model(s) stored in the on-device ML model(s) database 110A to process content described herein. For example, and as noted above, the content can be audibly rendered as audible content via the speaker(s) 134 of the wearable device 130. In these examples, the rendering engine 112 can process, using text-to-speech (TTS) model(s) stored in the on-device ML model(s) database 110A, content to generate synthesized speech audio data that includes computer-generated synthesized speech capturing the content.

Further, the client device 110, the remote system 120, and/or the wearable device 130 can include one or more memories for storage of data and/or software applications, one or more processors for accessing data and executing the software applications, one or more controllers for controlling operations executed thereon, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

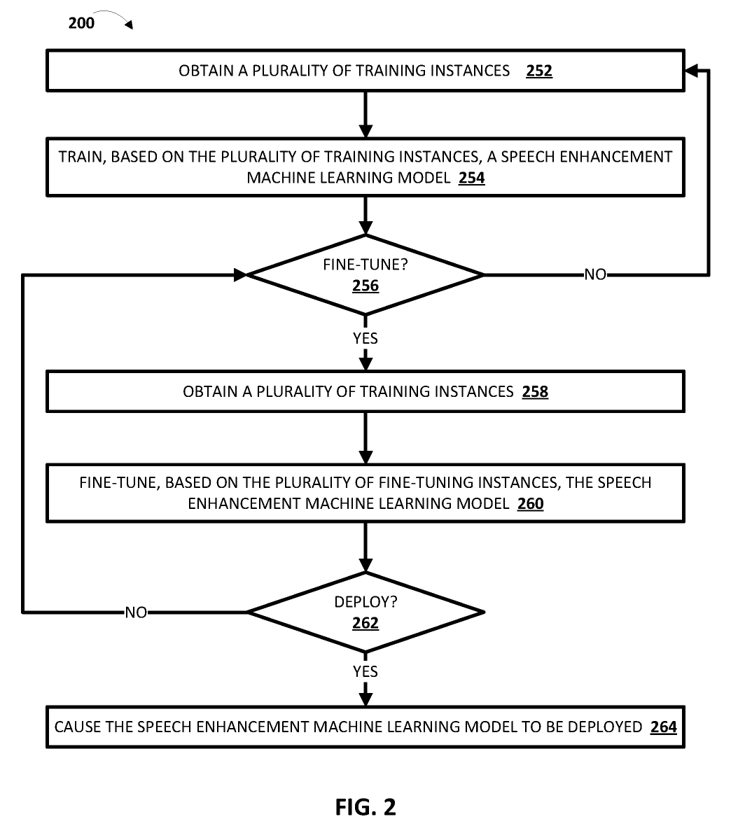

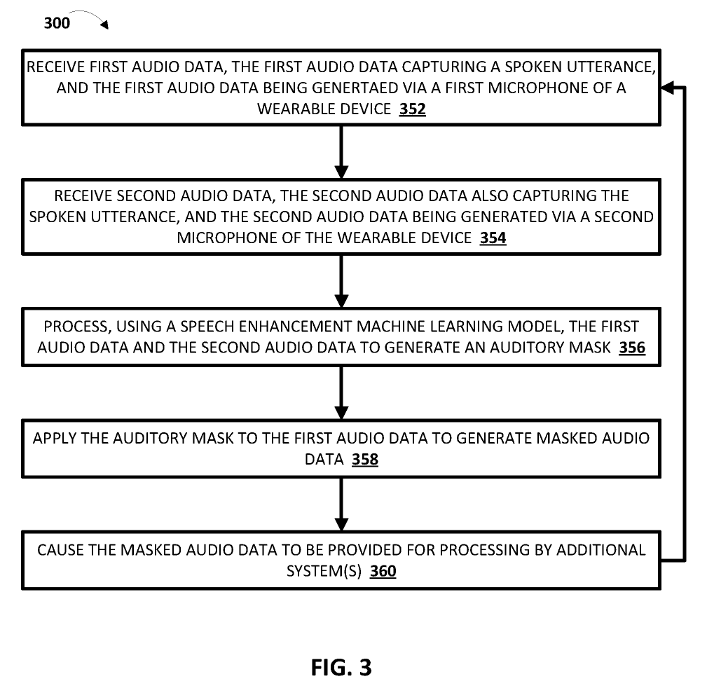

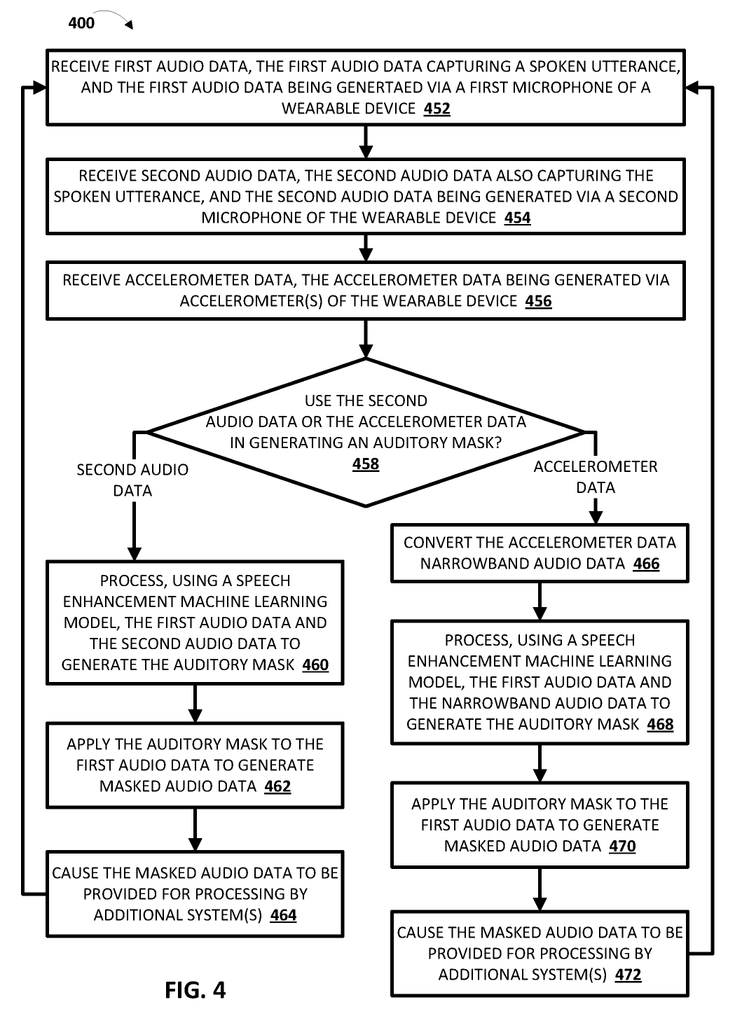

As described in more detail herein (e.g., with respect to FIGS. 2, 3, and 4), the remote system 120 can be utilized to train a speech enhancement ML model to generate auditory masks for audio data. The speech enhancement ML model can then be utilized by the client device 110 and/or the remote system 120 to enhance audio data prior to processing by additional system(s), such as the on-device ASR engine 115 and/or the on-device generative model (GM) engine 116 of the client device 110, and/or the remote ASR engine 124 and/or the remote GM engine 125 of the remote system 120. In some implementations, the auditory mask can be generated, for example, based on processing first audio data generated by the first microphone 131 of the wearable device 130 and based on processing second audio data generated by the second microphone 132 of the wearable device 130. In additional or alternative implementations, the auditory mask can be generated based on processing accelerometer data generated by the one or more accelerometers 133 of the wearable device 130 in addition to the second audio data generated by the second microphone 131 of the wearable device 130 or in lieu of the second audio data generated by the second microphone 131 of the wearable device 130. These techniques are particularly beneficial in situations where the wearable device 130 is an earbud since the first microphone 131 can be positioned outwards to capture a user's speech in environmental noise and the second microphone 132 can be positioned inwards to capture a less noisy, but less clear, version of the user's speech. However, it should be understood that these techniques may still be utilized even in situations where the wearable device 130 is not an earbud. Training of the speech enhancement ML model is described in more detail herein (e.g., with respect to FIG. 2). Further, using the speech enhancement ML model to enhance speech is described in more detail herein (e.g., with respect to FIGS. 3 and 4 ).

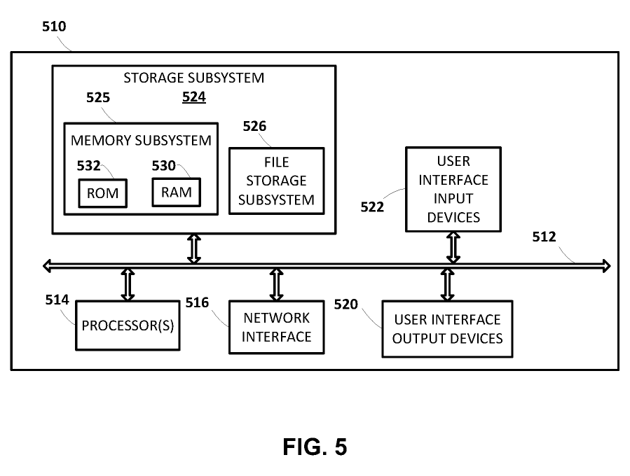

Turning now to FIG. 2, a flowchart illustrating an example method 200 of training a speech enhancement machine learning model is depicted. For convenience, the operations of the method 200 are described with reference to a system that performs the operations. This system of the method 200 includes one or more processors, memory, and/or other component(s) of computing device(s) (e.g., client device 110 of FIG. 1, remote system 120 of FIG. 1, computing device 510 of FIG. 5, one or more servers, and/or other computing devices). Moreover, while operations of the method 200 are shown in a particular order, this is not meant to be limiting. One or more operations may be reordered, omitted, and/or added.

At block 252, the system obtains a plurality of training instances. For example, the system can cause the training instance engine 121A to obtain the plurality of training instances from the training / fine-tuning instance database 121N. Each of the plurality of training instances can include, as training instance input, corresponding first training audio data capturing a synthesized spoken utterance and synthesized noise and corresponding second training audio data that captures the synthesized spoken utterance in a different manner (e.g., with a varied gain level or other variations). Further, each of the plurality of training instances can include, as training instance output, corresponding ground truth audio data that captures the synthesized spoken utterance in a different manner (e.g., without any synthetic noise and/or without a varied gain level).

At block 254, the system trains, based on the plurality of training instances, a speech enhancement machine learning model. For example, the system can cause the training / fine-tuning engine 121C to train the speech enhancement machine learning model using the plurality of training instances. In training the speech enhancement machine learning model based on a given training instance, the training / fine-tuning engine 121C can process, using the speech enhancement machine learning model, the first training audio data and the second training audio data to generate a predicted auditory mask, and can apply the predicted auditory mask to the first training audio data to generate predicted masked audio data. The predicted auditory mask can attempt to remove the synthesized noise that is included in the first training audio data and based on the second training audio data that captures the same synthesized spoken utterance but with the varied gain level that makes the synthesized spoken utterance in the second training audio data less clear. Further, in training the speech enhancement machine learning model based on the given training instance, the training / fine-tuning engine 121C can generate, based on comparing the predicted masked audio data to the ground truth audio data, loss(es) (e.g., gradient loss(es)). The training / fine-tuning engine 121C can then cause the speech enhancement machine learning model to be updated based on the loss(es) (e.g., using backpropagation). Notably, in comparing the predicted masked audio data to the ground truth audio data, the training / fine-tuning engine 121C can compare acoustic features of the predicted masked audio data to one or more acoustic features of the ground truth audio data, can compare a waveform corresponding to the predicted masked audio data to a waveform corresponding to the ground truth audio data, and/or other make other comparisons.

In some implementations, the training / fine-tuning engine 121C can cause the speech enhancement machine learning model to be updated based on other loss(es) in addition to the loss(es) noted above. For example, the training / fine-tuning engine 121C can further cause the predicted masked audio data to be processed, using an ASR model, to generate predicted text that is predicted to correspond to the synthesized spoken utterance. In this example, the training / fine-tuning engine 121C can further generate, based on comparing the predicted text to ground truth text (e.g., text corresponding speech in the synthesized spoken utterance) to generate ASR loss(es). In these implementations, the training / fine-tuning engine 121C can further cause the speech enhancement machine learning model to be updated based on the ASR loss(es) and without updating the ASR model. As another example, the training / fine-tuning engine 121C can further cause predicted masked audio data to be processed, using a GM model, to generate predicted responsive content that is predicted to correspond to the synthesized spoken utterance. In this example, the predicted response content can be provided for presentation to a user (e.g., a developer associated with the remote system), and the user can be prompted for feedback on the predicted responsive content. Based on the feedback provided by the user, one or more rewards can be generated by the training / fine-tuning engine 121C and utilized to update parameters of the speech enhancement machine learning model.

At block 256, the system determines whether to continue training the speech enhancement machine learning model or to fine-tune the speech enhancement machine learning model. For example, the system can determine whether to continue training the speech enhancement machine learning model or to fine-tune the speech enhancement machine learning model based on whether one or more training conditions are satisfied. The one or more training conditions can include, for example, whether the speech enhancement machine learning model has been trained using a threshold quantity of training instances, whether the speech enhancement machine learning model has been trained for a threshold quantity of time, whether there are additional training instances to train the speech enhancement machine learning model, and/or other training condition(s). If, at an iteration of block 256, the system determines to continue training the speech enhancement machine learning model, the system returns to block 252 to obtain a plurality of additional training instances and trains the speech enhancement machine learning model based on the plurality of additional training instances. If, at an iteration of block 256, the system determines to fine-tune the speech enhancement machine learning model, the system continues to block 258.

At block 258, the system obtains a plurality of fine-tuning instances. For example, the system can cause the fine-tuning instance engine 121B to obtain the plurality of fine-tuning instances from the training / fine-tuning instance database 121N. Each of the plurality of fine-tuning instances can include, as fine-tuning instance input, corresponding first fine-tuning audio data capturing a real spoken utterance and real noise and corresponding second fine-tuning audio data that captures the real spoken utterance in a different manner (e.g., from a different microphone). Further, each of the plurality of fine-tuning instances can include, as fine-tuning instance output, corresponding ground truth audio data that captures the real spoken utterance in a different manner (e.g., without any real noise and/or without a varied gain level).

At block 260, the system fine-tunes, based on the plurality of fine-tuning instances, the speech enhancement machine learning model. For example, the system can cause the training / fine-tuning engine 121C to train the speech enhancement machine learning model using the plurality of fine-tuning instances. In fine-tuning the speech enhancement machine learning model based on a given fine-tuning instance, the training / fine-tuning engine 121C can process, using the speech enhancement machine learning model, the first fine-tuning audio data and the second fine-tuning audio data to generate a predicted auditory mask, and can apply the predicted auditory mask to the first fine-tuning audio data to generate predicted masked audio data. The predicted auditory mask can attempt to remove the real noise that is included in the first fine-tuning audio data and based on the second fine-tuning audio data that captures the same real spoken utterance but from the other microphone that captures the real spoken utterance less clearly. Further, in fine-tuning the speech enhancement machine learning model based on the given fine-tuning instance, the training / fine-tuning engine 121C can generate, based on comparing the predicted masked audio data to the ground truth audio data, loss(es) (e.g., gradient loss(es)). The training / fine-tuning engine 121C can then cause the speech enhancement machine learning model to be updated based on the loss(es) (e.g., using backpropagation). Notably, in comparing the predicted masked audio data to the ground truth audio data, the training / fine-tuning engine 121C can compare acoustic features of the predicted masked audio data to one or more acoustic features of the ground truth audio data, can compare a waveform corresponding to the predicted masked audio data to a waveform corresponding to the ground truth audio data, and/or other make other comparisons.

In some implementations, the training / fine-tuning engine 121C can cause the speech enhancement machine learning model to be updated based on other loss(es) in addition to the loss(es) noted above, such as the ASR loss(es) and/or the reward(s) from the GM described above with respect to block 254 of the method 200.

At block 262, the system determines whether to deploy the speech enhancement machine learning model. For example, the system can determine whether to deploy the speech enhancement machine learning model based on whether one or more deployment conditions are satisfied. The one or more deployment conditions can include, for example, whether the speech enhancement machine learning model has been fine-tuned a threshold quantity of fine-tuning instances, whether the speech enhancement machine learning model has been fine-tuned a threshold quantity of time, whether there are additional fine-tuning instances to fine-tune the speech enhancement machine learning model, whether the speech enhancement machine learning model has achieved a threshold level of performance (e.g., in terms of precision and/or recall), and/or other deployment condition(s). If, at an iteration of block 262, the system determines not to deploy the speech enhancement machine learning model, the system returns to block 256 to determine whether to return to training the speech enhancement machine learning model or whether to continue fine-tuning the speech enhancement machine learning model. If, at an iteration of block 262, the system determines to deploy the speech enhancement machine learning model, the system continues to block 264.

At block 264, the system causes the speech enhancement machine learning model to be deployed. For example, the system can cause the speech enhancement model to be deployed for use locally at client device(s) and/or remote system(s) (e.g., as described with respect to FIGS. 3 and 4).

Although the method 200 of FIG. 2 is described with respect to training the speech enhancement machine learning model based on synthetic data and fine-tuning the speech enhancement machine learning model based on real data, it should be understood that is for the sake of example and is not meant to be limiting. Rather, it should be understood that training or fine-tuning of the speech enhancement machine learning model can be performed based on any combination of synthetic data and/or real data.

Further, although the method 200 of FIG. 2 is described with respect to training the speech enhancement machine learning model using only audio data, it should be understood that this is not meant to be limiting and one or more additional or alternative signals may be utilized to train the speech enhancement machine learning model. For example, in various implementations, the system can utilize corresponding accelerometer data in addition to or in lieu of the corresponding second audio data. In these implementations, the system can convert the accelerometer data to narrowband audio data by, for example, sampling the accelerometer data with a predetermined sampling frequency and effectively use the narrowband audio data in the same or similar manner as the corresponding second training audio data described above.

Turning now to FIG. 3, a flowchart illustrating an example method 300 of using a speech enhancement machine learning model to enhance speech is depicted. For convenience, the operations of the method 300 are described with reference to a system that performs the operations. This system of the method 300 includes one or more processors, memory, and/or other component(s) of computing device(s) (e.g., client device 110 of FIG. 1, remote system 120 of FIG. 1, computing device 510 of FIG. 5, one or more servers, and/or other computing devices). Moreover, while operations of the method 300 are shown in a particular order, this is not meant to be limiting. One or more operations may be reordered, omitted, and/or added.

At block 352, the system receives first audio data, the first audio data capturing a spoken utterance, and the first audio data being generated via a first microphone of a wearable device. At block 354, the system receives second audio data, the second audio data also capturing the spoken utterance, and the second audio data being generated via a second microphone of the wearable device. For example, the wearable device can be an earbud, the first microphone of the wearable device can be an outward-facing microphone positioned to capture the spoken utterance and environmental noise (e.g., the first microphone 131 of the wearable device 130), and the second microphone of the wearable device can be an inward-facing microphone positioned to capture the user's speech and less acoustically clear environmental noise (e.g., the second microphone 132 of the wearable device 130). Notably, the system can be implemented locally at a client device of a user that is wireless communication with the earbud, or the system can be implemented remotely from a client device of the user but in wireless communication with the client device of the user.

At block 356, the system processes, using a speech enhancement machine learning model, the first audio data and the second audio data to generate an auditory mask. At block 358, the system applies the auditory mask to the first audio data to generate masked audio data. For example, the system can cause the speech enhancement engine 114 of the client device 110 and/or the speech enhancement engine 123 of the remote system 120 to process, using the speech enhancement machine learning model, the first audio data generated by the first microphone and the second audio data generated by the second microphone to generate the auditory mask. Further, the system can cause the speech enhancement engine 114 of the client device 110 and/or the speech enhancement engine 123 of the remote system 120 to apply the auditory mask to the first audio data generated by the first microphone. Put another way, the system can concatenate the first audio data generated by the first microphone with the auditory mask in order to remove the environmental noise from the first audio data, thereby enhancing the user's speech that is captured in the first audio data.

At block 360, the system causes the masked audio data to be provided for processing by one or more additional systems. For example, the system can cause the masked audio data to be provided for processing by the on-device ASR engine 115 and/or the on-device generative model (GM) engine 116 of the client device 110 in implementations where the system is implemented locally at the client device 110. As another example, the system can cause the masked audio data to be provided for processing by the remote ASR engine 124 and/or the remote GM engine 125 of the remote system 120 in implementations where the system is implemented remotely from the client device 110. Further, any content that is responsive to the spoken utterance can be audibly rendered for presentation to the user (e.g., via the speaker(s) 134 of the wearable device 130).

The system returns to block 352 and continues processing, using the speech enhancement machine learning model, subsequent first audio data generated by the first microphone of the wearable device and subsequent second audio data generated by the second microphone of the wearable device to process and enhance the subsequent first audio data in the same or similar manner as described above.

Although the method 300 of FIG. 3 is described with respect to using the first audio data and the second audio data to generate the auditory mask, it should be understood that is for the sake of example and is not meant to be limiting. For example, in various implementations, the method 300 can further include receiving accelerometer data generated by accelerometer(s) of the wearable device while the user is speaking the spoken utterance (e.g., accelerometer(s) 133 of the wearable device 130). In these implementations, the system can convert the accelerometer data to narrowband audio data, and can process, using the speech enhancement machine learning model, the converted narrowband audio data with the first audio data and the second audio data or the converted narrowband audio data in lieu of the second audio data (e.g., when the wearable device is an earbud in transparency mode).

Further, although the wearable device is described above with respect to an earbud, it should be understood that this is not meant to be limiting. For example, the wearable device can be a smartwatch, a pair of computerized glasses, or a virtual or augmented reality computing device that includes multiple microphones pointing in different directions or that includes a microphone and an accelerometer.

Turning now to FIG. 4, a flowchart illustrating another example method 400 of using a speech enhancement machine learning model to enhance speech is depicted. For convenience, the operations of the method 400 are described with reference to a system that performs the operations. This system of the method 400 includes one or more processors, memory, and/or other component(s) of computing device(s) (e.g., client device 110 of FIG. 1, remote system 120 of FIG. 1, computing device 510 of FIG. 5, one or more servers, and/or other computing devices). Moreover, while operations of the method 400 are shown in a particular order, this is not meant to be limiting. One or more operations may be reordered, omitted, and/or added.

At block 452, the system receives first audio data, the first audio data capturing a spoken utterance, and the first audio data being generated via a first microphone of a wearable device. At block 454, the system receives second audio data, the second audio data also capturing the spoken utterance, and the second audio data being generated via a second microphone of the wearable device. For example, the wearable device can be an earbud, the first microphone of the wearable device can be an outward-facing microphone positioned to capture the spoken utterance and environmental noise (e.g., the first microphone 131 of the wearable device 130), and the second microphone of the wearable device can be an inward-facing microphone positioned to capture the user's speech and less acoustically clear environmental noise (e.g., the second microphone 132 of the wearable device 130).

At block 456, the system receives accelerometer data, the accelerometer data being generated via one or more accelerometers of the wearable device. Continuing with the above example where the wearable device is an earbud, the system can receive the accelerometer data from the accelerometer(s) 133 of the wearable device 130 that is/are located internally to the wearable device 130.

At block 458, the system determines whether to use the second audio data or the accelerometer data in generating an auditory mask. For example, the system can cause the wearable device mode determination engine 113 and/or the wearable device mode determination engine 122 to determine whether to use either the second audio data or the accelerometer data in generating the auditory mask based on a mode of operation of the wearable device. Continuing with the above example where the wearable device is an earbud, the mode of operation can be a transparency mode where the earbud lets environmental noise flow through the earbud, a noise cancellation mode where the earbud attempts to minimize environmental noise from passing through the earbud, an off mode where the earbud does not block the environmental noise from passing through the earbud like in the noise cancellation mode and does not allow the environmental noise to flow through the earbud like in the transparency mode, or other mode(s) of operation that can optionally vary based on a type of the wearable device (e.g., when the wearable device is computerized glasses, a smartwatch, or a virtual or augmented reality computing device). Notably, the user of the wearable device can have control over the mode of operation of the wearable device by interacting with the wearable device or a client device that is in wireless communication with the wearable device.

For instance, in implementations where the wearable device is in transparency mode, the system can determine to use the accelerometer data in lieu of the second audio data since the second audio data would be too noisy for utilization in generating the auditory mask. Nonetheless, the system can utilize the accelerometer data in lieu of the second audio data. However, in implementations where the wearable device is not in transparency mode but instead in noise cancellation mode or off mode, the system can determine to utilize the second audio data in generating the auditory mask, and optionally also use the accelerometer data.

If, at an iteration of block 458, the system determines to use the second audio data in generating the auditory mask, the system proceeds to block 460. At block 460, the system processes, using the speech enhancement machine learning model, the first audio data and the second audio data to generate the auditory mask. At block 462, the system applies the auditory mask to the first audio data to generate masked audio data. At block 464, the system causes the masked audio data to be provided for processing by one or more additional systems. The operations of blocks 460, 462, and 464 of the method 400 of FIG. 4 can be performed in the same or similar manner as described with respect to the operations of blocks 356, 358, and 360 of the method 300 of FIG. 3, respectively.

The system returns to block 452 and continues processing, using the speech enhancement machine learning model, subsequent first audio data generated by the first microphone of the wearable device, and subsequent second audio data generated by the second microphone of the wearable device and/or subsequent accelerometer data generated by the accelerometer(s) of the wearable device to process and enhance the subsequent first audio data in the same or similar manner as described above.

If, at an iteration of block 458, the system determines to use the accelerometer data in generating the auditory mask, the system proceeds to block 466.

At block 466, the system converts the accelerometer data to narrowband audio data. For example, the system can convert the accelerometer data to the narrowband audio data by sampling the accelerometer data with a predetermined sampling frequency so that the accelerometer data is in a format usable by the speech enhancement machine learning model. Notably, the predetermined sampling frequency allows for conversion into a narrowband audio signal that reflects the vibrations and movements associated with speech. This narrowband audio data can then be leveraged by the speech enhancement machine learning model.

At block 468, the system processes, using the speech enhancement machine learning model, the first audio data and the narrowband audio data to generate the auditory mask. At block 470, the system applies the auditory mask to the first audio data to generate masked audio data. At block 472, the system causes the masked audio data to be provided for processing by one or more additional systems. The operations of blocks 468, 470, and 472 of the method 400 of FIG. 4 can be performed in the same or similar manner as described with respect to the operations of blocks 356, 358, and 360 of the method 300 of FIG. 3, respectively, but using the narrowband audio data instead of the second audio data.

The system returns to block 452 and continues processing, using the speech enhancement machine learning model, subsequent first audio data generated by the first microphone of the wearable device, and subsequent second audio data generated by the second microphone of the wearable device and/or subsequent accelerometer data generated by the accelerometer(s) of the wearable device to process and enhance the subsequent first audio data in the same or similar manner as described above.

Although the method 400 of FIG. 4 is described with respect to using either the second audio data to generate the auditory mask or the accelerometer data to generate the auditory mask, it should be understood that is for the sake of example and is not meant to be limiting. Rather, it should be understood that in some implementations, the system can utilize both the second audio data and the accelerometer data in generating the auditory mask.

Further, although the wearable device is described above with respect to an earbud, it should be understood that this is not meant to be limiting. For example, the wearable device can be a smartwatch, a pair of computerized glasses, or a virtual or augmented reality computing device that includes multiple microphones pointing in different directions or that includes a microphone and an accelerometer.

Turning now to FIG. 5, a block diagram of an example computing device 510 that may optionally be utilized to perform one or more aspects of techniques described herein is depicted. In some implementations, one or more of a client device, multi-modal response system component(s) or other cloud-based software application component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term "input device" is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term "output device" is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIGS. 1 and 2.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user’s social network, social actions or activities, profession, a user’s preferences, or a user’s current geographic location), or to control whether and/or how to receive content from the content server that may be more relevant to the user. Also, certain data may be treated in one or more ways before it is stored or used, so that personal identifiable information is removed. For example, a user’s identity may be treated so that no personal identifiable information can be determined for the user, or a user’s geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving first audio data, the first audio data capturing a spoken utterance, and the first audio data being generated via a first microphone of a wearable device; receiving second audio data, the second audio data also capturing the spoken utterance, and the second audio data being generated via a second microphone of the wearable device; processing, using a speech enhancement machine learning model, the first audio data and the second audio data to generate an auditory mask; applying the auditory mask to the first audio data to generate masked audio data; and causing the masked audio data to be provided for processing by one or more additional systems.

These and other implementations of technology disclosed herein can optionally include one or more of the following features.

In some implementations, the wearable device can be an earbud.

In some versions of those implementations, the first microphone can be an outward facing microphone that faces outwards from an ear of a user that is wearing the earbud, and the second microphone can be an inward facing microphone that faces inwards into the ear of the user that is wearing the earbud.

In some versions of those implementations, the first audio data can also capture environmental noise of an environment in which the user is located while providing the spoken utterance, and the auditory mask applied to the first audio data can mask the environmental noise.

In some implementations, the method can further include, prior to processing the first audio data and the second audio data to generate the auditory mask and using the speech enhancement machine learning model: determining, based on the earbud being in a non-transparency mode from among a plurality of different modes, to process the first audio data and the second audio data to generate the auditory mask and using the speech enhancement machine learning model.

In some implementations, the speech enhancement machine learning model can be a conformer-based machine learning model that is trained to generate the auditory mask.

In some implementations, the method can further include, prior to receiving the first audio data and prior to receiving the second audio data: training the speech enhancement machine learning model. Training the speech enhancement machine learning model can include: obtaining a plurality of training instances, each of the plurality of training instances including training instance input and training instance output; and training, based on the plurality of training instances, the speech enhancement machine learning model.

In some versions of those implementations, the training instance input can include first training audio data and second training audio data, the first training audio data can capture a synthesized spoken utterance and added synthesized noise, and the second training audio data can capture the synthesized spoken utterance with a varied gain level and/or varied synthesized noise. Further, the training instance output can include ground truth audio data that captures the synthesized spoken utterance without any added noise and without any varied gain level.

In some further versions of those implementations, training the speech enhancement machine learning model based on a given training instance, of the plurality of training instances, can include: processing, using the speech enhancement machine learning model, the first training audio data and the second training audio data to generate a predicted auditory mask; applying the predicted auditory mask to the first training audio data to generate predicted masked audio data; generating, based on comparing the predicted masked audio data to the ground truth audio data, one or more losses; and updating, based on the one or more losses, the speech enhancement machine learning model.

In some yet further versions of those implementations, training the speech enhancement machine learning model based on the given training instance, of the plurality of training instances, can further include: processing, using an automatic speech recognition (ASR) model, the predicted masked audio data to generate predicted text that is predicted to correspond to the synthesized spoken utterance; generating, based on comparing the text that is predicted to correspond to the synthesized spoken utterance to ground truth text that corresponds to the synthesized spoken utterance, one or more additional losses; and updating, based on the one or more additional losses, the speech enhancement machine learning model and without updating the ASR model.

In other versions of those implementations, the method can further include, subsequent to training the speech enhancement machine learning model: fine-tuning the speech enhancement machine learning model. Fine-tuning the speech enhancement machine learning model can include: obtaining a plurality of fine-tuning instances, each of the plurality of fine-tuning instances including fine-tuning instance input and fine-tuning instance output; and fine-tuning, based on the plurality of fine-tuning instances, the speech enhancement machine learning model.

In further versions of those implementations, the fine-tuning instance input can include first fine-tuning audio data and second fine-tuning audio data, the first fine-tuning audio data can capture a real spoken utterance and real noise generated by an outward facing microphone that faces outwards from an ear of a user that is wearing an earbud, and the second fine-tuning audio data can capture the real spoken utterance captured by an inward facing microphone that faces inwards into the ear of the user that is wearing the earbud. Further, the fine-tuning instance output can include ground truth audio data generated by an additional microphone that is separate from the earbud and that captures the real spoken utterance without the real noise.

In some yet further versions of those implementations, fine-tuning the speech enhancement machine learning model based on a given fine-tuning instance, of the plurality of fine-tuning instances, can include: processing, using the speech enhancement machine learning model, the first fine-tuning audio data and the second fine-tuning audio data to generate a predicted auditory mask; applying the predicted auditory mask to the first fine-tuning audio data to generate predicted masked audio data; generating, based on comparing the predicted masked audio data to the ground truth audio data, one or more losses; and updating, based on the one or more losses, the speech enhancement machine learning model.

In even yet further versions of those implementations, fine-tuning the speech enhancement machine learning model based on the given fine-tuning instance, of the plurality of fine-tuning instances, can further include: processing, using an automatic speech recognition (ASR) model, the predicted masked audio data to generate predicted text that is predicted to correspond to the real spoken utterance; generating, based on comparing the text that is predicted to correspond to the real spoken utterance to ground truth text that corresponds to the real spoken utterance, one or more additional losses; and updating, based on the one or more additional losses, the speech enhancement machine learning model and without updating the ASR model.

In some implementations, the method can further include: receiving accelerometer data, the accelerometer data being generated via one or more accelerometers of the wearable device; converting the accelerometer data to narrowband audio data; and processing, using the speech enhancement machine learning model, and along with the first audio data and the second audio data, the narrowband audio data to generate the auditory mask.

In some versions of those implementations, converting the accelerometer data to the narrowband audio data can include sampling the accelerometer data with a predetermined sampling frequency.

In some implementations, the one or more processors can be local to a client device of a user, and the client device of the user can be in wireless communication with the wearable device.

In some versions of those implementations, causing the masked audio data to be provided for processing by the one or more additional systems can include: causing the masked audio data to be provided for processing by an on-device automatic speech recognition (ASR) model to generate recognized text corresponding to the spoken utterance that is captured in the first audio data and that is also captured in the second audio data.

In some further versions of those implementations, causing the masked audio data to be provided for processing by the one or more additional systems can further include: causing the recognized text corresponding to the spoken utterance that is captured in the first audio data and that is also captured in the second audio data to be provided for processing by an on-device generative model (GM) to generate responsive content that is responsive to the spoken utterance.

In other versions of those implementations, causing the masked audio data to be provided for processing by the one or more additional systems can include: causing the masked audio data to be provided for processing by an on-device generative model (GM) to generate responsive content that is responsive to the spoken utterance.

In some implementations, the one or more processors can be remote from a client device of a user, and the client device of the user can be in wireless communication with the wearable device.

In some versions of those implementations, causing the masked audio data to be provided for processing by the one or more additional systems can include: causing masked audio data to be provided for processing by a remote automatic speech recognition (ASR) model to generate recognized text corresponding to the spoken utterance that is captured in the first audio data and that is also captured in the second audio data.

In some further versions of those implementations, causing the masked audio data to be provided for processing by the one or more additional systems can further include: causing the recognized text corresponding to the spoken utterance that is captured in the first audio data and that is also captured in the second audio data to be provided for processing by a remote generative model (GM) to generate responsive content that is responsive to the spoken utterance.

In other versions of those implementations, causing the masked audio data to be provided for processing by the one or more additional systems can include: causing the masked audio data to be provided for processing by a remote generative model (GM) to generate responsive content that is responsive to the spoken utterance.

In some implementations, a method implemented by one or more processors is provided, and includes: receiving first audio data, the first audio data capturing a spoken utterance, and the first audio data being generated via a first microphone of a wearable device; receiving second audio data, the second audio data also capturing the spoken utterance, and the second audio data being generated via a second microphone of the wearable device; receiving accelerometer data, the accelerometer data being generated via one or more accelerometers of the wearable device; determining, based on a mode of the wearable device and from among a plurality of modes of the wearable device, whether to process the first audio data and the second audio data to generate an auditory mask; and in response to determining to process the first audio data and the second audio data to generate the auditory mask based on the mode of the wearable device: processing, using a speech enhancement machine learning model, the first audio data and the second audio data to generate the auditory mask; applying the auditory mask to the first audio data to generate masked audio data; and causing the masked audio data to be provided for processing by one or more additional systems.

These and other implementations of technology disclosed herein can optionally include one or more of the following features.

In some implementations, the method can further include: receiving accelerometer data, the accelerometer data being generated via an accelerometer of the wearable device; and in response to determining to not process the first audio data and the second audio data to generate the auditory mask based on the mode of the wearable device: converting the accelerometer data to narrowband audio data; processing, using the speech enhancement machine learning model, and along with the first audio data and the narrowband audio data to generate the auditory mask; applying the auditory mask to the first audio data to generate masked audio data; and causing the masked audio data to be provided for processing by the one or more additional systems.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving first audio data, the first audio data capturing a spoken utterance, and the first audio data being generated via a first microphone of a wearable device;
receiving second audio data, the second audio data also capturing the spoken utterance, and the second audio data being generated via a second microphone of the wearable device;
processing, using a speech enhancement machine learning model, the first audio data and the second audio data to generate an auditory mask;
applying the auditory mask to the first audio data to generate masked audio data; and
causing the masked audio data to be provided for processing by one or more additional systems.

2. The method of claim 1, wherein the wearable device comprises an earbud.

3. The method of claim 2, wherein the first microphone is an outward facing microphone that faces outwards from an ear of a user that is wearing the earbud, and wherein the second microphone is an inward facing microphone that faces inwards into the ear of the user that is wearing the earbud.

4. The method of claim 2, wherein the first audio data also captures environmental noise of an environment in which the user is located while providing the spoken utterance, and wherein the auditory mask applied to the first audio data masks the environmental noise.

5. The method of claim 2, further comprising:
prior to processing the first audio data and the second audio data to generate the auditory mask and using the speech enhancement machine learning model:
determining, based on the earbud being in a non-transparency mode from among a plurality of different modes, to process the first audio data and the second audio data to generate the auditory mask and using the speech enhancement machine learning model.

6. The method of claim 1, wherein the speech enhancement machine learning model is a conformer-based machine learning model that is trained to generate the auditory mask.

7. The method of claim 1, further comprising:
prior to receiving the first audio data and prior to receiving the second audio data:
training the speech enhancement machine learning model, wherein training the speech enhancement machine learning model comprises:
obtaining a plurality of training instances, each of the plurality of training instances including training instance input and training instance output; and
training, based on the plurality of training instances, the speech enhancement machine learning model.

8. The method of claim 7,
wherein the training instance input includes first training audio data and second training audio data,
wherein the first training audio data captures a synthesized spoken utterance and added synthesized noise,
wherein the second training audio data captures the synthesized spoken utterance with a varied gain level and/or varied synthesized noise,
wherein the training instance output includes ground truth audio data that captures the synthesized spoken utterance without any added noise and without any varied gain level.

9. The method of claim 8, wherein training the speech enhancement machine learning model based on a given training instance, of the plurality of training instances, comprises:
processing, using the speech enhancement machine learning model, the first training audio data and the second training audio data to generate a predicted auditory mask;
applying the predicted auditory mask to the first training audio data to generate predicted masked audio data;
generating, based on comparing the predicted masked audio data to the ground truth audio data, one or more losses; and
updating, based on the one or more losses, the speech enhancement machine learning model.

10. The method of claim 9, wherein training the speech enhancement machine learning model based on the given training instance, of the plurality of training instances, further comprises:
processing, using an automatic speech recognition (ASR) model, the predicted masked audio data to generate predicted text that is predicted to correspond to the synthesized spoken utterance;
generating, based on comparing the text that is predicted to correspond to the synthesized spoken utterance to ground truth text that corresponds to the synthesized spoken utterance, one or more additional losses; and
updating, based on the one or more additional losses, the speech enhancement machine learning model and without updating the ASR model.

11. The method of claim 7, further comprising:
subsequent to training the training the speech enhancement machine learning model based on the plurality of training instances:
fine-tuning the speech enhancement machine learning model, wherein fine-tuning the speech enhancement machine learning model comprises:
obtaining a plurality of fine-tuning instances, each of the plurality of fine-tuning instances including fine-tuning instance input and fine-tuning instance output; and
fine-tuning, based on the plurality of fine-tuning instances, the speech enhancement machine learning model.

12. The method of claim 11,
wherein the fine-tuning instance input includes first fine-tuning audio data and second fine-tuning audio data,
wherein the first fine-tuning audio data captures a real spoken utterance and real noise generated by an outward facing microphone that faces outwards from an ear of a user that is wearing an earbud,
wherein the second fine-tuning audio data captures the real spoken utterance captured by an inward facing microphone that faces inwards into the ear of the user that is wearing the earbud, and
wherein the fine-tuning instance output includes ground truth audio data generated by an additional microphone that is separate from the earbud and that captures the real spoken utterance without the real noise.

13. The method of claim 12, wherein fine-tuning the speech enhancement machine learning model based on a given fine-tuning instance, of the plurality of fine-tuning instances, comprises:
processing, using the speech enhancement machine learning model, the first fine-tuning audio data and the second fine-tuning audio data to generate a predicted auditory mask;
applying the additional predicted auditory mask to the first fine-tuning audio data to generate predicted masked audio data;
generating, based on comparing the predicted masked audio data to the ground truth audio data, one or more losses; and
updating, based on the one or more losses, the speech enhancement machine learning model.

14. The method of claim 13, wherein fine-tuning the speech enhancement machine learning model based on the given fine-tuning instance, of the plurality of fine-tuning instances, further comprises:
processing, using an automatic speech recognition (ASR) model, the predicted masked audio data to generate predicted text that is predicted to correspond to the real spoken utterance;
generating, based on comparing the text that is predicted to correspond to the real spoken utterance to ground truth text that corresponds to the real spoken utterance, one or more additional losses; and
updating, based on the one or more additional losses, the speech enhancement machine learning model and without updating the ASR model.

15. The method of claim 1, further comprising:
receiving accelerometer data, the accelerometer data being generated via one or more accelerometers of the wearable device;
converting the accelerometer data to narrowband audio data; and
processing, using the speech enhancement machine learning model, and along with the first audio data and the second audio data, the narrowband audio data to generate the auditory mask.

16. The method of claim 15, wherein converting the accelerometer data to the narrowband audio data comprises sampling the accelerometer data with a predetermined sampling frequency.

17. The method of claim 1, wherein the one or more processors are local to a client device of a user, and wherein the client device of the user is in wireless communication with the wearable device.

18. The method of claim 17, wherein causing the masked audio data to be provided for processing by the one or more additional systems comprises:
causing the masked audio data to be provided for processing by an on-device automatic speech recognition (ASR) model to generate recognized text corresponding to the spoken utterance that is captured in the first audio data and that is also captured in the second audio data.

19. A system comprising:
at least one processor; and
memory storing instructions that, when executed by the at least one processor, cause the at least one processor to be operable to:
receive first audio data, the first audio data capturing a spoken utterance, and the first audio data being generated via a first microphone of a wearable device;
receive second audio data, the second audio data also capturing the spoken utterance, and the second audio data being generated via a second microphone of the wearable device;
process, using a speech enhancement machine learning model, the first audio data and the second audio data to generate an auditory mask;
apply the auditory mask to the first audio data to generate masked audio data; and
cause the masked audio data to be provided for processing by one or more additional systems.

20. A non-transitory computer-readable storage medium storing instructions that, when executed by at least one processor, cause the at least one processor to perform operations to:
receive first audio data, the first audio data capturing a spoken utterance, and the first audio data being generated via a first microphone of a wearable device;
receive second audio data, the second audio data also capturing the spoken utterance, and the second audio data being generated via a second microphone of the wearable device;
process, using a speech enhancement machine learning model, the first audio data and the second audio data to generate an auditory mask;
apply the auditory mask to the first audio data to generate masked audio data; and
cause the masked audio data to be provided for processing by one or more additional systems.
